(19) United States
(12) Patent Application Publication
(10) Pub. No.: US 2003/0122650 A1
(43) Pub. Date: Jul. 3, 2003

(54) Thermal protector

(76) Inventors: Kiyoshi Yamamoto, Tokyo (JP); Takeshi Nagai, Nikko-shi (JP)

Correspondence Address: LORUSSO & LOUD, 3137 Mount Vernon Avenue, Alexandria, VA, 22305, US

(21) Appl. No.: 10/313,006

(22) Filed: Dec. 6, 2002

(30) Foreign Application Priority Data
Dec. 7, 2001 (JP) 2001/374373
Mar. 29, 2002 (JP) 2002/096857

(51) Int. Cl. H01H 37/52

(52) U.S. Cl. 337/333; 337/342

(57) ABSTRACT

There is disclosed a thermal protector, which comprises an insulating resin-made flat case having a case body and a cover body joined with the case body; a fixed electrode having a fixed contact located on an inner bottom portion of the case body and a terminal part exposed to the outside of the case body, the fixed electrode being fixed to the case body; a movable electrode having, on a tip end thereof, a movable contact, while having, on a basal end thereof, a terminal part fixed to the cover body and having a portion exposed to the outside of the cover body, the movable electrode being placed such as to allow, by a spring action thereof, the movable contact to make contact with the fixed contact, the basal end of the movable electrode being fixed to the cover body; and a thermo-reactive element housed in the case so as to allow the movable electrode to operate to disconnect the movable contact from the fixed contact when a predetermined operating temperature of the thermo-reactive element is reached.

### BACKGROUND OF THE INVENTION

1. Field of the Invention

This invention relates to a thermal protector of a structure, which allows a movable contact to disconnect from a fixed contact by utilizing a snap action of a thermo-reactive element at a time when a predetermined operating temperature of the thermo-reactive element is reached, thereby breaking a circuit.

2. Description of the Prior Art

A thermal protector of this kind is used as a protective component, which breaks a circuit against an over-current or overheat of a secondary battery or the like generally used for various motors and electric appliances. More specifically, thermal protectors such as one for a secondary battery used for a mobile phone, a notebook-sized personal computer or the like, one for a small-sized motor, one for a DC circuit to give protection to an automobile motor and a charger and one for an AC circuit to give protection to a general-purpose motor used for an air conditioner fan, an electric washing machine and other electric appliances are included, for instance.

Recently, with a realization of smaller-sized higher-performance electric appliances, there has been also a need for a smaller-sized higher-performance thermal protector as one used for these electric appliances.

In Japanese Patent Laid-open No 2001-307607, for instance, there is disclosed a thermal protector as shown in FIG. 26 as one of thermal protectors, which meet the above need.

FIG. 26 is a cross-sectional view showing the thermal protector disclosed in the above Japanese Patent Laid-open No. 2001-307607. A square flat case 1a is composed of a case body 10a and a cover body 11a tightly joined with the case body 10a. The cover body 11a has an insulating resin-made edge frame 11b and a thin metal-made cover top plate 11c, which are provided in one united body by insert molding.

A fixed electrode 20a having a fixed contact 2a is united with one end of an inner bottom portion of the case body 10a by insert molding. The fixed electrode 20a also has a terminal part 21a extending in one united body therefrom to the outside of the case 1a.

The case body 10a has a support part 10b whose upper surface has a holding projection 10c in one united body. A movable electrode 30a whose lower surface of a tip end has a movable contact 3a is fixed to the holding projection 10c by caulking. The movable electrode 30a also has a terminal part 31a extending in one united body therefrom to the outside of the case 1a.

The movable electrode 30a also has, on portions thereof respectively located in the vicinity of the movable contact 3a and in the vicinity of the holding projection 10c, engaging pieces 30b, 30c provided by skiving. The opposite ends of a thermo-reactive element 4a made up of a bimetal plate formed in a convex spherical shape are in engagement with the engaging pieces 30b, 30c.

The cover top plate 11c of the cover body 11a has a convex part 11d slightly protrusive toward the thermo-reactive element 4a. The convex part 11d serves to press a central portion of the thermo-reactive element 4a downwards.

The thermal protector as described above is installed to each required portion of the electric appliances such that the terminal parts 21a, 31a of the thermal protector to be mounted are connected to wiring electrode terminal parts in a circuit substrate or the like (not shown), for instance.

When the thermal protector is installed as described above, and in this state, an over-current or overheat causes a rise of a temperature on the inside of the case 1a with the result that the temperature on the inside of the case 1a reaches an operating temperature or above of the thermo-reactive element 4a, the thermo-reactive element 4a is snapped so as to creep into a concave spherical shape. Then, the thermo-reactive element 4a allows, by a snap action thereof, the movable electrode 30a to disconnect the movable contact 3a from the fixed contact 2a, thereby interrupting a current.

In addition, in Japanese Patent Laid-open No. 9-306316, for instance, there is disclosed a thermal protector as shown in FIG. 25.

FIG. 25 is a cross-sectional view showing the thermal protector disclosed in the above Japanese Patent Laid-open No. 9-306316. In a case 1 composed of a case body 10a and a cover body 11a are sealed up a fixed electrode 20a whose one end has a fixed contact 2a, and a movable electrode 30a whose one end has a movable contact 3a and whose the other end is connected with a terminal part 31a.

The movable electrode 30a is made up of a thermo-reactive element snapped at a time when a predetermined operating temperature thereof is reached, thereby allowing, by a spring action thereof, the movable contact 3a to make contact with the fixed contact 2a. The terminal part 21a of the fixed electrode 20a and the terminal part 31a of the movable electrode 30a are designed to lead to the outside of the case 1 through the ends thereof so as to form the tip ends of the terminal parts 21a, 31a flat, and the flat tip end portions thereof are subjected to bending so as to make contact with a bottom surface of the case body 10a.

The thermal protector as described above is installed to each required portion of the electric appliances such that the terminal parts 21a, 31a of the thermal protector to be mounted are connected to wiring electrode terminal parts in a circuit substrate or the like (not shown), for instance. When the thermal protector is installed as described above, and in this state, an over-current or overheat causes a rise of a temperature on the inside of the case with the result that the temperature on the inside of the case reaches an operating temperature or above of the movable electrode 30a, the movable electrode 30a is snapped so as to allow, by a snap action thereof, the movable contact 3a to disconnect from the fixed contact 2a, thereby interrupting a current at a disconnected contact portion.

With the above structure, the thermal protector shown in FIG. 26 is producible to have a small size (a small thickness), and besides, ensures that a high contact pressure is applied to the contacts.

For a small-sized thermal protector whose characteristics are largely changeable depending on size variations, the thermal protector shown in FIG. 26, however, needs a large number of assemble steps, thereby bringing about wide size variations, resulting in a degraded yield and also a low productivity.

On the other hand, the thermal protector shown in FIG. 25 is structured such that the terminal parts 21a, 31a thereof are designed to lead to the outside of the case 1 so as to form the tip ends of the terminal parts 21a, 31a flat, and the flat tip end portions thereof are subjected to bending so as to make contact with the bottom surface of the case body 10a, thereby eliminating a need for leads used to mount the thermal protector to the electric appliances. This provides a higher performance for the thermal protector with a decrease in electric resistance, facilitates to mount the thermal protector to the circuit substrate or the like and also ensures that a miniaturization of the whole structure including the thermal protector is attainable.

According to the thermal protector shown in FIG. 25, however, the cover body 11a may not ensure that a structural strength is provided for the thermal protector, unless a thickness of the cover body 11a is increased.

### SUMMARY OF THE INVENTION

It is an object of the present invention to provide a thermal protector, which has a smaller size, is less need for an assemble step, ensures a higher size accuracy and besides, is highly yielded.

Another object of the present invention is to provide a thermal protector, which easily ensures that a structural strength is provided for the overall structure.

A thermal protector according to the present invention has the following structure in order to attain the above objects.

That is, a thermal protector as one of modes according to the present invention comprises an insulating resin-made flat case having a case body and a cover body joined with the case body; a fixed electrode having a fixed contact located on an inner bottom portion of the case body and a terminal part exposed to the outside of the case body, the fixed electrode being fixed to the case body; a movable electrode having, on a tip end thereof, a movable contact, while having, on a basal end thereof, a terminal part fixed to the cover body and having a portion exposed to the outside of the cover body, the movable electrode being placed so as to allow, by a spring action thereof, the movable contact to make contact with the fixed contact, the basal end of the movable electrode being fixed to the cover body; and a thermo-reactive element housed in the case so as to allow the movable electrode operate to disconnect the movable contact from the fixed contact when a predetermined operating temperature of the thermo-reactive element is reached.

A thermal protector as a different mode according to the present invention comprises an insulating resin-made flat case having a case body and a cover body joined with the case body; a fixed electrode having a fixed contact located on an inner bottom portion of the case body and a terminal part exposed to the outside of the case body, the fixed electrode being fixed to the case body; and a movable electrode made up of a thermo-reactive element having, on a tip end thereof, a movable contact, while having, on a basal end thereof, a terminal part fixed to the cover body and having a portion exposed to the outside of the cover body, the thermo-reactive element being placed so as to allow, by a spring action thereof, the movable contact to make contact with the fixed contact, while allowing the movable contact to disconnect from the fixed contact when a predetermined operating temperature of the thermo-reactive element is reached, the basal end of the thermo-reactive element being fixed to the cover body.

A thermal protector as a further different mode according to the present invention comprises an insulating resin-made flat case having a case body and a cover body joined with the case body; a fixed electrode having a fixed contact located on an inner bottom portion of the case body and a plate-shaped terminal part at least having a portion exposed to the outside of the case body along a bottom surface thereof, the fixed electrode being fixed to the case body; a different fixed electrode having a different fixed contact located on an inner bottom portion of the case body so as to keep away from the fixed contact of the above fixed electrode and a different plate-shaped terminal part fixed to the cover body such that at least a portion of the different plate-shaped terminal part is exposed to the outside of the cover body along an upper surface thereof, the different fixed electrode being fixed to the case body; a movable electrode having, on the opposite ends thereof, movable contacts respectively corresponding to the above fixed contacts, the movable electrode being housed in the case so as to allow, by a spring action thereof, each of the movable contacts to make contact with a corresponding one of the fixed contacts; and a thermo-reactive element housed in the case so as to allow the movable electrode to operate to disconnect each of the movable contacts from the corresponding one of the fixed contacts when a predetermined operating temperature of the thermo-reactive element is reached.

A thermal protector according to a still further different mode according to the present invention comprises an insulating resin-made flat case having a case body and a cover body joined with the case body; a fixed electrode having a fixed contact located on an inner bottom portion of the case body and a plate-shaped terminal part at least having a portion exposed to the outside of the case body along a bottom surface thereof, the fixed electrode being fixed to the case body; a different fixed electrode having a different fixed contact located on an inner bottom portion of the case body so as to keep away from the fixed contact of the above fixed electrode and a different plate-shaped terminal part fixed to the cover body such that at least a portion of the different plate-shaped terminal part is exposed to the outside of the cover body along an upper surface thereof, the different fixed electrode being fixed to the case body; and a movable electrode made up of a thermo-reactive element having, on the opposite ends thereof, movable contacts respectively corresponding to the above fixed contacts, the thermo-reactive element being housed in the case so as to allow, by a spring action thereof, each of the movable contacts to make contact with a corresponding one of the fixed contacts, while allowing each of the movable contacts to disconnect from the corresponding one of the fixed contacts when a predetermined operating temperature of the thermo-reactive element is reached.

### BRIEF DESCRIPTION OF THE DRAWINGS

The foregoing and other objects and features of the invention will become apparent from the following description of the embodiments of the invention with reference to the accompanying drawings, in which:

FIG. 1A is a cross-sectional view showing a first embodiment of a thermal protector according to the present invention;

FIG. 1B is a cross-sectional view showing a state that the thermal protector of FIG. 1A is operated;

FIG. 2 is a bottom view showing the thermal protector of FIG. 1A;

FIG. 3 is a cross-sectional view showing a second embodiment of the thermal protector according to the present invention;

FIG. 4 is a cross-sectional view showing a third embodiment of the thermal protector according to the present invention;

FIG. 5 is a cross-sectional view showing a fourth embodiment of the thermal protector according to the present invention;

FIG. 6 is a cross-sectional view showing a fifth embodiment of the thermal protector according to the present invention;

FIG. 7 is a cross-sectional view showing a sixth embodiment of the thermal protector according to the present invention;

FIG. 8 is a cross-sectional view showing a seventh embodiment of the thermal protector according to the present invention;

FIG. 9 is a cross-sectional view showing an eighth embodiment of the thermal protector according to the present invention;

FIG. 10 is a cross-sectional view showing a ninth embodiment of the thermal protector according to the present invention;

FIG. 11 is a cross-sectional view showing a state that the thermal protector of FIG. 10 is operated;

FIG. 12 is a side view showing the thermal protector of FIG. 10;

FIG. 13C is a plan view showing a cover body of the thermal protector of FIG. 10;

FIG. 13D is a bottom view showing the cover body of the thermal protector of FIG. 10;

FIG. 13E is a cross-sectional view taken along line A-A of FIG. 13C;

FIG. 14F is a plan view showing a case body of the thermal protector of FIG. 10;

FIG. 14G is a bottom view showing the case body of the thermal protector of FIG. 10;

FIG. 14H is a plan view showing a thermo-reactive element of the thermal protector of FIG. 10;

FIG. 15 is a front view showing a tenth embodiment of the thermal protector according to the present invention;

FIG. 16 is a plan view showing the thermal protector of FIG. 15;

FIG. 17 is a bottom view showing the thermal protector of FIG. 15;

FIG. 18 is a cross-sectional view showing an eleventh embodiment of the thermal protector according to the present invention;

FIG. 19 is a cross-sectional view showing a twelfth embodiment of the thermal protector according to the present invention;

FIG. 20 is a cross-sectional view showing a thirteenth embodiment of the thermal protector according to the present invention;

FIG. 21 is a plan view showing the thermal protector of FIG. 20;

FIG. 22 is a bottom view showing the thermal protector of FIG. 20;

FIG. 23 is a cross-sectional view showing a fourteenth embodiment of the thermal protector according to the present invention;

FIG. 24 is a cross-sectional view showing a fifteenth embodiment of the thermal protector according to the present invention;

FIG. 25 is a cross-sectional view showing a thermal protector described in Japanese Patent Laid-open No. 9-306316; and

FIG. 26 is a cross-sectional view showing a thermal protector described in Japanese Patent Laid-open No. 2001-307607.

### DETAILED DESCRIPTION OF PREFERRED EMBODIMENTS

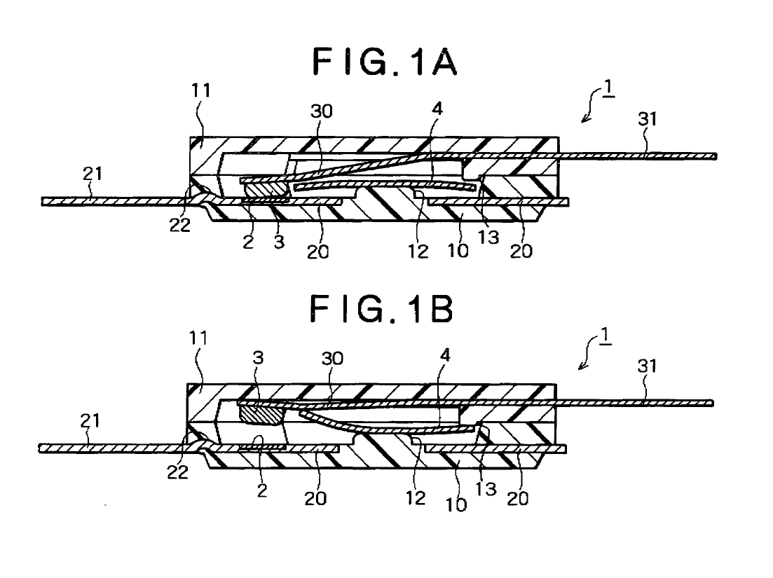

Preferred embodiments of a thermal protector according to the present invention will be described with reference to FIGS. 1 to 24.

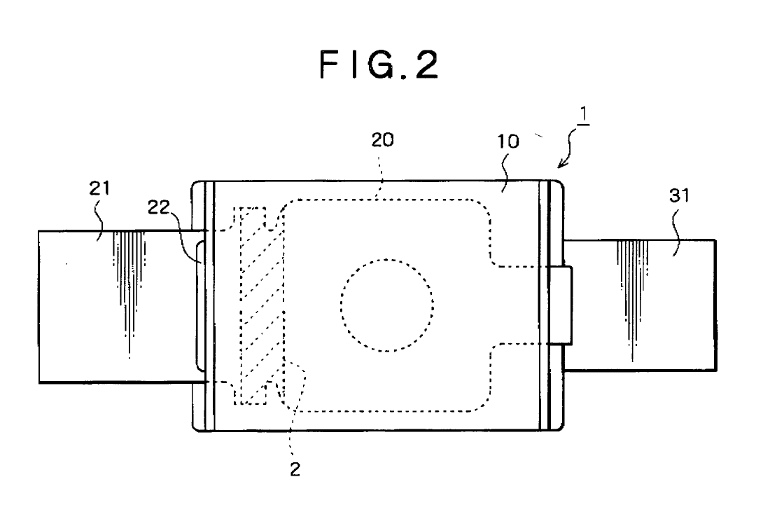

First of all, a first embodiment of the thermal protector according to the present invention will now be described with reference to FIGS. 1 and 2.

The thermal protector in the first embodiment relates to one mode corresponding to a thermal protector according to claims 1, 6 and 9, which will be described later.

An insulating resin-made oblong flat case 1 is composed of a substantially tray-shaped thin case body 10 and a cover body 11 tightly joined with the case body 10.

In the case 1 are sealed up a plate-shaped fixed electrode 20 whose one end has a fixed contact 2 clad thereto so as to be exposed to the inside of the case 1, a springy movable electrode 30 whose tip end has a movable contact 3 making contact with the fixed contact 2, and a thermo-reactive element 4 snapped when a predetermined operating temperature thereof is reached.

The fixed contact 2 and the movable contact 3 are provided to be in contact with each other under a predetermined pressure by a spring action of the movable electrode 30, while being disconnected from each other by a snap action of the thermo-reactive element 4.

The plate-shaped fixed electrode 20 and the movable electrode 30 are respectively united with terminal parts 21, 31 extending from the case 1 sideward. One terminal part 21 extends from one end of the case body 10, while the other terminal part 31 extends from the other end of the cover body 11.

The thermo-reactive element 4 made up of a bimetal is formed to have a substantially convex spherical shape (an overturned dish-shape) or a convex semicircular shape. In addition, the thermo-reactive element 4 is designed to have a plane area as wide as possible to the extent that the thermo-reactive member 4 may not interfere with other members during snapping operation. The thermo-reactive element 4 is housed in the case so as to be placed between the movable electrode 30 and an inner bottom surface of the case body 10 such that a substantially central portion of the thermo-reactive element 4 is mounted on a convex-shaped seat part 12 provided on the inner bottom surface of the case body 10, and one end thereof is located in the vicinity of the movable contact 3, while the other end thereof is provided to lead to a portion right beneath a convex part 13 protrusive toward an inner surface of a corresponding end of the cover body 11.

The fixed electrode 20 including the fixed contact 2 is fixed to the insulating resin-made case body 10, while a basal end (a movable electrode portion other than an operating part of the movable electrode 30) of the movable electrode 30 and a portion of the terminal part 31 are fixed to the cover body 11.

According to the thermal protector in the first embodiment, the fixed electrode 20 is united with the inner bottom surface of the insulating resin-made case body 10 by insert molding so as to be substantially inlaid in the inner bottom surface thereof, thereby occupying the greater part of the inner bottom surface thereof. A joint portion of the fixed electrode 20 with the terminal part 21 is provided to extend through a peripheral wall on one side of the case body 10 and also has, in advance, a strip-shaped projection 22 extending in a cross direction thereof, thereby enhancing an adhesion strength and a sealing performance of the case body 10 with the fixed electrode 20 after the case body 10 and the fixed electrode 20 are united together by insert molding.

The basal end of the movable electrode 30 and a joint portion of the terminal part 31 with the movable electrode 30 are united with the insulating resin-made cover body 11 by insert molding so as to extend through a peripheral wall on one side of the cover body 11 and also to be level with an inner top surface of the cover body 11.

The thermal protector in the first embodiment is manufactured by the steps of forming the case body 10 and the cover body 11 as described above, then housing the thermo-reactive element 4 in the case body 10, and then tightly joining the cover body 11 with the case body 10 one upon the other by ultrasonic bonding or the like.

Polyphenylene sulfide (PPS), liquid crystal polymer (LCP), polybutylene terephthalate (PBT) and other highly heat-resistant resins are used as a material to form the case body 10 and the cover body 11. Particularly, when the thermal protector is adapted for the purpose of mounting a surface thereof to the circuit substrate or the like, liquid crystal polymer having a heat resistance against a temperature of 200° C. or above is preferably used.

Copper is preferably used as a material of the fixed electrode 20 and the terminal part 21. Alternatively, a conductive material such as phosphor bronze, Cu—Ti alloy, Cu—Be alloy, nickel silver, brass and Cu—Ni—Si alloy may be also used.

Cu—Be alloy is preferably used as a material of the movable electrode 30 and the terminal part 31. Alternatively, a conductive springy material such as phosphor bronze, Cu—Ti alloy, nickel silver, brass and Cu—Ni—Si alloy may be also used.

Nickel-silver alloy is preferably used as a material of the fixed contact 2 and the movable contact 3. More preferably, silver alloy containing 10 mass % of nickel is used, for instance. Alternatively, a contact material such as copper-silver alloy, gold-silver alloy, carbon-silver alloy and tungsten-silver alloy may be also used as the material of the fixed contact 2 and the movable contact 3. It does not matter whether these contacts 2, 3 are joined with the electrodes 20, 30 by cladding, plating, caulking or other specific means.

A thermo-reactive element of a layered structure composed of a high thermo-expansive metal material based on Cu—Ni—Mn alloy and a low thermo-expansive metal material based on Ni—Fe alloy is used as the thermo-reactive element 4.

When the thermal protector in the first embodiment is installed to the electric appliance or the like, and in this state, a current is normally flowing between the contacts, the movable contact 3 is in contact with the fixed contact 2 so as to be pressed against the fixed contact 2 by an elasticity of the movable electrode 30, as shown in FIG. 1A.

On the other hand, when an extraordinary current flow between the contacts or other factors cause a rise of a temperature on the inside of the case 1 with the result that the temperature on the inside of the case 1 reaches an operating temperature or above of the thermo-reactive element 4, the thermo-reactive element 4 is snapped to creep upwards into a concave spherical shape such as to be tensed on the convex-shaped seat part 12 by a snap action. The thermo-reactive element 4 is snapped as described above, thereby allowing the movable contact 3 to disconnect from the fixed contact 2 as shown in FIG. 1B, resulting in an interruption of a current between the contacts.

When the thermo-reactive element 4 is snapped, one end of the thermo-reactive element 4 is pressed against the projection 13 provided on the inner top surface of the cover body 11, so that the other end of the thermo-reactive element 4 may be snapped upwards more quickly.

Firstly, the thermal protector in the first embodiment is structured such that the fixed electrode 20 is united with the case body 10 by insert molding, and the basal end (inclusive of a basal end of the terminal part 31) of the movable electrode 30 is also united with the cover body 11 by insert molding, thereby ensuring that a structural strength is provided for the case body 10 and the cover body 11. In addition, the thermal protector in the first embodiment may be manufactured by joining the case body 10 and the cover body 11, which have been formed as described above, with each other, so that there is less need for an assemble step, thereby providing a higher size accuracy even for a small-sized thermal protector, and also improving a yield thereof.

Secondly, the thermal protector in the first embodiment has the fixed electrode 20 whose portion inserted into a thickness portion of the case body 10 has the projection 22, thereby enhancing the adhesive strength and the sealing performance of the case body 10 with the fixed electrode 20 after the case body 10 and the fixed electrode 20 are united together by insert molding.

Thirdly, the thermal protector in the first embodiment has the case body 10 whose inner bottom portion has the convex-shaped seat part 12 on which the substantially central portion of the thermo-reactive element 4 is mounted, and also the cover body 11 whose inner top surface has the projection 13 against which the basal end of the thermo-reactive element 4 is pressed during snapping operation, so that the tip end, close to the movable contact 3, of the thermo-reactive element 4 may be snapped upwards more quickly, thereby providing a satisfactory switching operability.

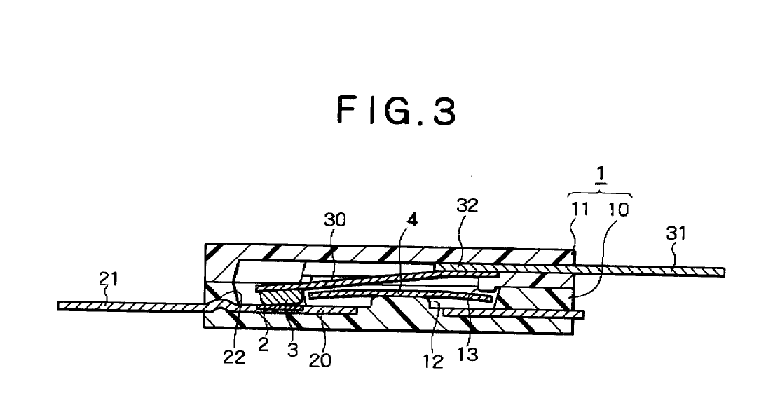

A second embodiment of the thermal protector according to the present invention will now be described with reference to FIG. 3.

The thermal protector shown in FIG. 3 relates to another mode corresponding to a thermal protector according to claims 1, 6 and 9, which will be described later.

The thermal protector in the second embodiment is provided as a modification of the thermal protector in the first embodiment. Specifically, the basal end of a movable electrode 30 is electrically connected (joined) with an electrode joint portion 32 united with a terminal part 31 on the movable electrode side so as to be protrusive into a case 1.

The movable electrode 30 is joined with the terminal part 31 as described above, thereby allowing a material different from that of the movable electrode 30, such as small springy conductive metal, for instance, to be used as the material of the terminal part 31. Alternatively, a member different in thickness from the movable electrode 30 may be also used for the terminal part 31.

The basal end of the movable electrode 30 is joined with the terminal part 31 as shown in FIG. 3, and thereafter, one end of the terminal part 31 inclusive of the electrode joint portion 32 is united with a cover body 11 of the case 1 by insert molding.

A fixed electrode 20 is united with a case body 10 of the case 1 by insert molding in the similar manner to the thermal protector in the first embodiment. Thereafter, a thermo-reactive element 4 is housed in the case body 10, and the case body 10 and the cover body 11 are tightly joined together by ultrasonic bonding or the like.

According to the thermal protector in the second embodiment, the movable electrode 30 is joined with the terminal part 31, and thereafter, a joint portion of the terminal part 31 with the movable electrode 30 is united with the cover body 11 of the case 1 by insert molding. Thus, the joint portion of the terminal part 31 with the movable electrode 30 is covered with a resin, so that a higher accuracy is provided for the joint portion, thereby allowing the thermal protector to perform more stable make-and-break between the contacts.

Other constitution, operation and effects of the thermal protector in the second embodiment are substantially similar to those of the thermal protector in the first embodiment, and hence, a detailed description thereof will be omitted.

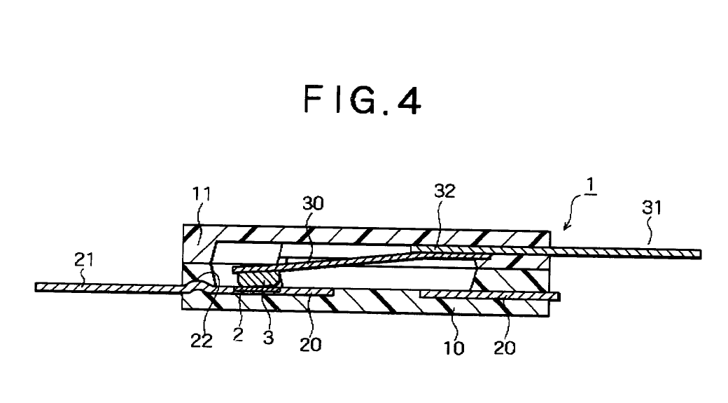

A third embodiment of the thermal protector according to the present invention will now be described with reference to FIG. 4.

The thermal protector shown in FIG. 4 corresponds to a thermal protector according to claims 2, 6 and 9, which will be described later.

A movable electrode 30 is made up of a springy thermo-reactive element (a bimetal plate in the third embodiment), and the basal end thereof is electrically connected to an electrode joint portion 32 of a terminal part 31 in the similar manner to the thermal protector in the second embodiment.

The basal end of the movable electrode 30 is joined with the electrode joint portion 32 of the terminal part 31, and thereafter, a joint portion of the terminal part 31 with the movable electrode 30 is united with a cover body 11 of a case 1 by insert molding. A case body 10 having a fixed electrode 20 united therewith by insert molding is joined with the cover body 11 formed as described above.

A movable contact 3 is pressed against a fixed contact 2 by elasticity of the movable electrode 30. When the temperature on the inside of the case 1 rises up to the operating temperature or above of the movable electrode 30, the tip end of the movable electrode 30 is snapped upwards, thereby allowing the movable contact 3 to disconnect from the fixed contact 2, resulting in a breaking of an electric circuit.

The thermal protector in the third embodiment allows the movable electrode 30 thereof to also serve as the thermo-reactive element, thereby proportionally reducing the number of components, and also breaking the contacts by the snap action of the movable electrode 30 itself, resulting in a further increase in switching operation speed.

Other constitution, operation and effects of the thermal protector in the third embodiment are substantially similar to those of the thermal protector in the second embodiment, and hence, a detailed description thereof will be omitted.

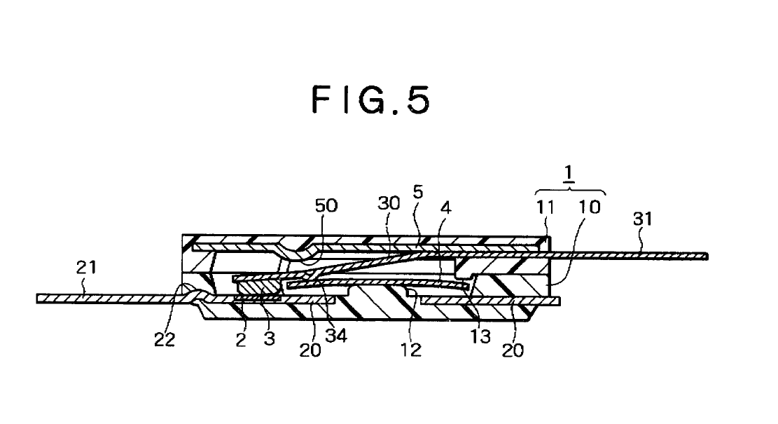

A fourth embodiment of the thermal protector according to the present invention will now be described with reference to FIG. 5.

The thermal protector shown in FIG. 5 corresponds to a thermal protector according to claims 6, 10 and 12, which will be described later.

A terminal part 31 of a movable electrode 30 is united with a cover body 11 of an insulating resin-made case 1 by insert molding. In addition, the cover body 11 also has a heat conductive plate 5 provided by insert molding so as to be inlaid in the cover body 11 such as to conduct a heat on the outside of the case 1 to the movable electrode 30. The heat conductive plate 5 is a metal plate of high thermal conductivity, and the basal end side of the movable electrode 30 united with the terminal part 31 is joined with the inner surface side of the heat conductive plate 5. For instance, a ceramics material and a composite material, in addition to the metal plate, may be also used as a material of the heat conductive plate 5, so long as these materials have high thermal conductivity.

The heat conductive plate 5 is provided for the cover body 11 by insert molding so as to be located on an inner top surface of the cover body 11. In addition, the heat conductive plate 5 has an inward projection 50 such that the movable electrode 30 collides against the projection 50 at a time when a movable contact 3 is disconnected from a fixed contact 2 so as to be apart therefrom by a certain distance.

The movable electrode 30 has, on a portion located closer to the basal end thereof than the movable contact 3, a projection 34 protrusive toward a thermo-reactive element 4 such that the thermo-reactive element 4 collides against the projection 34 at a time when the thermo-reactive element 4 is snapped by the snap action thereof.

The thermal protector in the third embodiment allows the heat on the outside of the case 1 to be efficiently conducted to the thermo-reactive element 4 through the heat conductive plate 5 and the movable electrode 30, thereby further improving an operating performance. The movable electrode 30 collides against the protection 50 during operation, thereby preventing the movable electrode 30 from being crept in excess of the limitation of elasticity thereof, resulting in the extended life of the movable electrode 30.

The heat conductive plate 5 also serves to reinforce a top surface wall of the cover body 11.

In snapping operation, the thermo-reactive element 4 collides against the projection 34 on the movable electrode 30 in the course of snapping operation, so that the position of the thermo-reactive element 4 is settled quickly, thereby controlling that unsettled positioning of the thermo-reactive element 4 is attributable to snapping or restoring thereof, and also further increasing an operation speed of the movable electrode 30.

Other constitution, operation and effects of the thermal protector in the fourth embodiment are substantially similar to those of the thermal protector in the first embodiment, and hence, a detailed description thereof will be omitted.

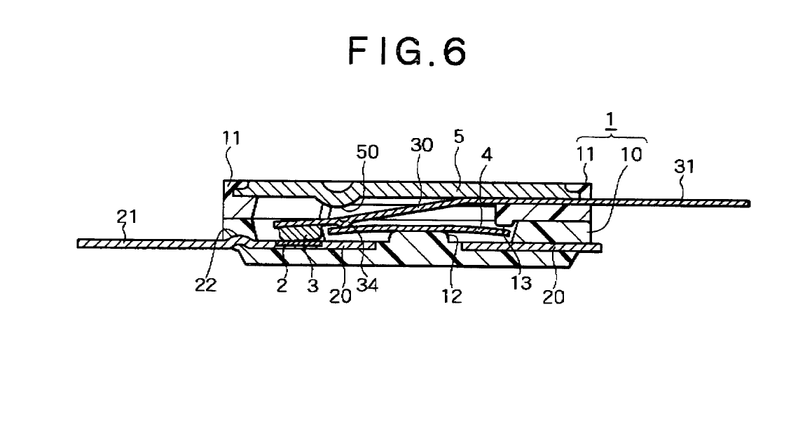

A fifth embodiment of the thermal protector according to the present invention will now be described with reference to FIG. 6.

The thermal protector shown in FIG. 6 corresponds to a thermal protector according to claims 9, 10, 11 and 12, which will be described later.

A heat conductive plate 5 is united with a cover body 11 of a case 1 by insert molding so as to form the whole top surface wall of the cover body 11, and an upper surface of the heat conductive plate 5 is exposed to the outside of the case 1 along an upper surface thereof For instance, a ceramics material and a composite material, in addition to the metal plate, may be also used as the material of the heat conductive plate 5, so long as these materials have high thermal conductivity.

A movable electrode 30 has a projection 34 protrusive toward a thermo-reactive element 4 in the same manner to the thermal protector in the fourth embodiment shown in FIG. 5.

The thermal protector in the fifth embodiment has the heat conductive plate 5 exposed to the outside of the case 1, so that the heat on the outside of the case 1 may be conducted from the movable electrode 30 to the thermo-reactive clement 4 through the heat conductive plate 5 more efficiently.

In addition, metal having high thermal conductivity and also the same conductivity as that of the movable electrode 30 may be used as the material of the heat conductive plate 5. When the heat conductive plate 5 is exposed to the outside of the case 1 along the upper surface thereof and is also made up of the conductive metal as described above, it is possible to use the heat conductive plate 5 also as a terminal part on the side of the movable electrode 30, thereby increasing a degree of freedom of electrical connection of the thermal protector to the electrical appliances when the thermal protector is mounted thereto.

Other constitution, operation and effects of the thermal protector in the fifth embodiment are substantially similar to those of the thermal protector in the fourth embodiment, and hence, a detailed description thereof will be omitted.

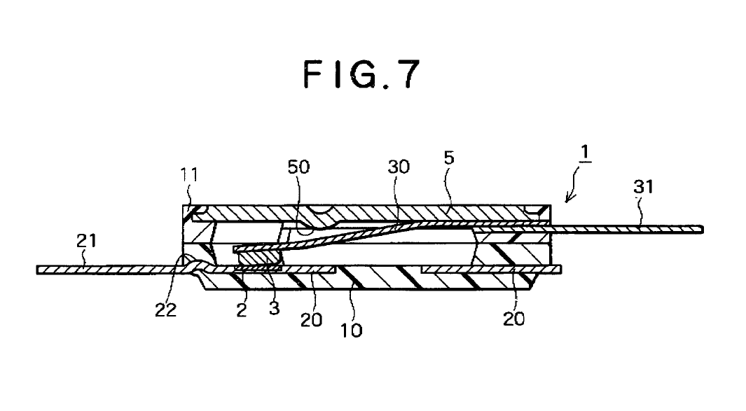

A sixth embodiment of the thermal protector according to the present invention will now be described with reference to FIG. 7.

The thermal protector shown in FIG. 7 corresponds to a thermal protector according to claims 9, 10, 11 and 12, which will be described later.

A movable electrode 30 and a terminal part 31 thereof are provided individually, and the movable electrode 30 is a springy thermo-reactive element. A lower surface of the basal end side of the movable electrode 30 is electrically connected to an end of the terminal part 31, while an upper surface of the basal end side of the movable electrode 30 is joined with a heat conductive plate 5. A joint portion of the terminal part 31 with the movable electrode 30 is united with a cover body 11 of a case 1 together with the heat conductive plate 5 by insert molding. A conductive metal material is used as the material of the heat conductive plate 5. The heat conductive plate 5 has, on an inner surface side thereof, a projection 50 such that the movable electrode 30 collides against the projection 50 at a time when a movable contact 3 is disconnected from a fixed contact 2 so as to be apart therefrom by a certain distance.

The thermal protector in the sixth embodiment allows the movable electrode 30 thereof to also serve as the thermo-reactive element, thereby proportionally reducing the number of components, as compared with the thermal protector in the fifth embodiment, and also breaking the contacts by the snap action of the movable electrode 30 itself, resulting in a further increase in switching operation speed.

Other operation and effects of the thermal protector in the sixth embodiment are substantially similar to those of the thermal protector in the fifth embodiment so far as the thermal protector in the sixth embodiment has the same constitution as that in the fifth embodiment, and hence, a detailed description thereof will be omitted.

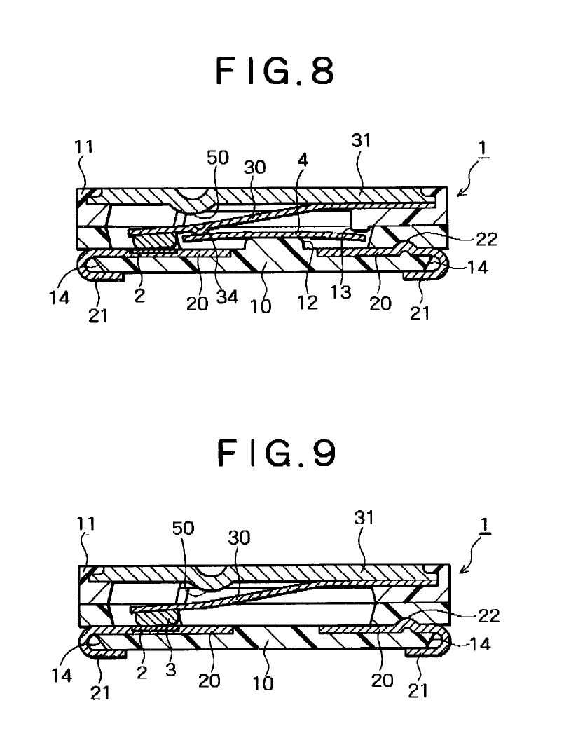

A seventh embodiment of the thermal protector according to the present invention will now be described with reference to FIG. 8.

The thermal protector shown in FIG. 8 corresponds to a thermal protector according to claims 1, 3, 7, 9, 14, 15, 16 and 18, which will be described later.

A fixed electrode 20 united with an insulating resin-made case body 10 of a case 1 by insert molding so as to be located on the inner bottom portion of the case body 10 has a plurality of terminal parts 21, 21. The terminal parts 21, 21 are subjected to bending at the opposite ends of the fixed electrode 20 so as to extend along a bottom surface of the case body 10.

Specifically, the thermal protector in the seventh embodiment is structured such that the terminal parts 21, 21 are respectively subjected to bending in a U-shaped folded-back shape such as to be provided to lead along notch-shaped guide parts 14, 14 provided on the opposite end bottom portions of the case body 10. Thus, the terminal parts 21, 21 are provided not to be protrusive from the periphery of the case 1 sideward.

The thermal protector in the seventh embodiment has the fixed electrode 20 whose proper portion inserted into a thickness portion of the case body 10 has a strip-shaped projection 22 extending in a cross direction thereof, thereby enhancing the adhesive strength and the sealing performance of the case body 10 with the fixed electrode 20.

A terminal part 31 is joined with an upper surface of a basal end of a movable electrode 30 so as to be overlapped with the movable electrode 30. The terminal part 31 and the movable electrode 30 inclusive of a joint portion of the terminal part 31 with the movable electrode 30 are united with a cover body 11 by insert molding. One surface of the terminal part 31 joined with the movable electrode 30 is exposed to the outside of the cover body 11 along an upper surface thereof and also forms a top surface wall of the cover body 11. The terminal part 31 has, on an inner surface side thereof, a projection 50 such that the movable electrode 30 collides against the projection 50 at a time when a movable contact 3 is disconnected from a fixed contact 2 so as to be apart therefrom by a certain distance.

The movable electrode 30 has, on a lower portion thereof close to the tip end thereof, a projection 34 protrusive toward a thermo-reactive element 4 in the similar manner to the thermal protector in the fourth embodiment shown in FIG. 5.

The case body 10 and the cover body 11 are formed as described above, and thereafter, the thermo-reactive element 4 is housed in the case body 10. The case body 10 and the cover body 11 are tightly joined together by ultrasonic bonding or the like, for instance, and thereafter, the terminal parts 21, 21 of the fixed electrode 20 are subjected to bending as shown in FIG. 8, thereby providing the thermal protector in final shape.

The fixed electrode 20 has the terminal parts 21, 21 extending along the bottom surface of the case body 10 and the movable electrode 30 has the terminal part 31 extending along the upper surface of the cover body 11, so that the thermal protector in the seventh embodiment is suitably adaptable to a case where the target circuit substrates for mounting the thermal protector are located on the upper and lower sides, and is also producible to have a smaller size. In addition, the movable electrode 30 has the terminal part 31 provided so as to form the top surface wall of the cover body 11, so that the thermal protector in the seventh embodiment is producible to be more firm as a whole and also to have a smaller thickness and a smaller size.

The terminal part 31 of the movable electrode is provided so as to occupy the greater part of one surface of the case 1, and a required portion of the terminal part 31 having the wide surface may be selectively mounted to the circuit substrate, thereby increasing a degree of freedom of mounting of the thermal protector.

The terminal parts 21, 31 are provided not to be protrusive from all the peripheral side surfaces of the case 1, thereby increasing a spatial efficiency when the thermal protector is adapted for surface mounting purposes.

Other constitution, operation and effects of the thermal protector in the seventh embodiment are substantially similar to those of the thermal protector in the fifth embodiment, and hence, a detailed description thereof will be omitted.

An eighth embodiment of the thermal protector according to the present invention will now be described with reference to FIG. 9.

The thermal protector shown in FIG. 9 corresponds to a thermal protector according to claims 2, 3, 7, 9, 14, 15, 16 and 18, which will be described later.

The thermal protector in the eighth embodiment is different from the thermal protector (the seventh embodiment) shown in FIG. 8 in that a movable electrode 30 of the thermal protector in the eighth embodiment is made up of a springy thermo-reactive member, and a case 1 thereof has a case body 10 having no convex-shaped seat part (See FIG. 8) and a cover body 11 having no projection 13 (See FIG. 8).

The thermal protector in the eighth embodiment allows the movable electrode 30 thereof to also serve as the thermo-reactive element, thereby proportionally reducing the number of components enough to manufacture the thermal protector at lower cost, as compared with the thermal protector in the seventh embodiment, and also breaking the contacts by the snap action of the movable electrode 30 itself, resulting in a further increase in switching operation speed.

Other operation and effects of the thermal protector in the eighth embodiment are substantially similar to those of the thermal protector in the seventh embodiment so far as the thermal protector in the eighth embodiment has the same constitution as that in the seventh embodiment, and hence, a detailed description thereof will be omitted.

Each of the thermal protectors in the fourth and fifth embodiments shown in FIGS. 5 and 6 has the movable electrode 30 and the terminal part 31, which are provided in one united body. Alternatively, the above thermal protectors may be also embodied by electrically connecting or joining the basal end side of the movable electrode 30 with the terminal part 31 united with the cover body 11 of the case 1 by insert molding.

The thermal protector in the sixth embodiment shown in FIG. 7 may have the heat conductive plate 5 replaced with the heat conductive plate 5 of the thermal protector in the fourth embodiment shown in FIG. 5. The thermal protector having the heat conductive plate 5 as described above corresponds to a terminal protector according to claims 10 and 12, which will be described later.

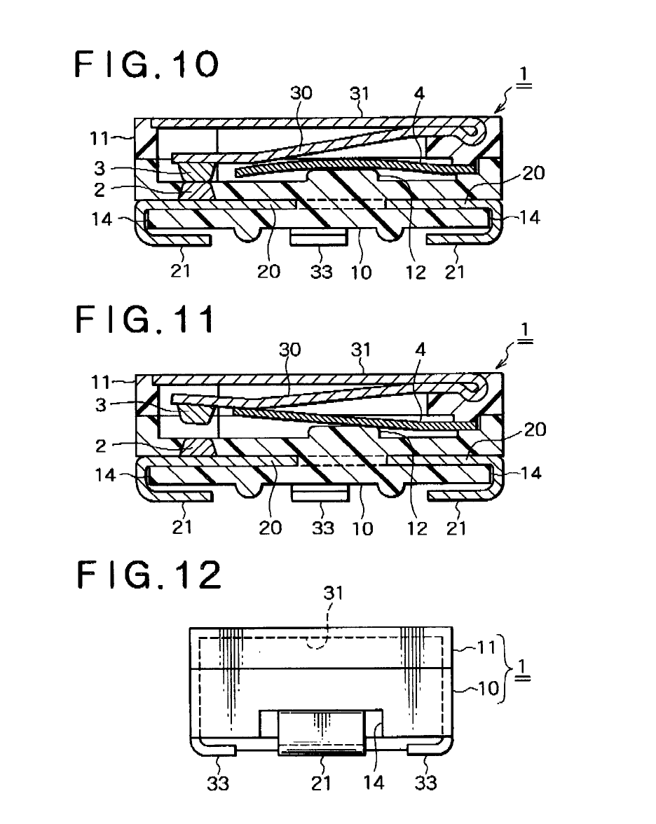

A ninth embodiment of the thermal protector according to the present invention will now be described with reference to FIGS. 10 to 14.

The thermal protector shown in FIGS. 10 to 14 corresponds to a thermal protector according to claims 3, 7, 18, and 19, which will be described later.

An oblong flat case 1 is composed of a substantially tray-shaped case body 10 and a cover body 11 provided to seal up the case body 10.

In the case 1 are sealed up a fixed contact 2, a springy plate-shaped movable electrode 30 whose tip end has a movable contact 3 making contact with the fixed contact 2 and a thermo-reactive element 4 snapped when a predetermined operating temperature thereof is reached. A fixed electrode 20 connected to the fixed contact 2 and the movable electrode 30 respectively have flat terminal parts 21, 31 exposed to the outside of the case 1. One terminal parts 21, 21 are placed along a bottom surface of the case body 10, while the other terminal part 31 is placed along an upper surface of the cover body 11.

According to the thermal protector in the ninth embodiment, the fixed contact 2 is mounted to one end of an inner bottom portion of the case body 10 so as to be inlaid in the inner bottom portion thereof, and the fixed electrode 20 connected to the fixed contact 2 extends horizontally through a thickness portion of the bottom of the case body 10. In addition, a plurality of flat terminal parts 21, 21 subjected to bending such that the tip ends thereof are level with each other so as to extend in parallel to the bottom surface of the case 1 are united with the longitudinally opposite ends of the fixed electrode 20.

The terminal parts 21, 21 have the portions subjected to bending in a folded-back shape so as to be provided to lead along notch-shaped guide parts 14, 14 vertically provided on the longitudinally opposite end bottom portions of the case body 10. Thus, the terminal parts 21, 21 are provided not to be protrusive from the opposite ends of the case 1.

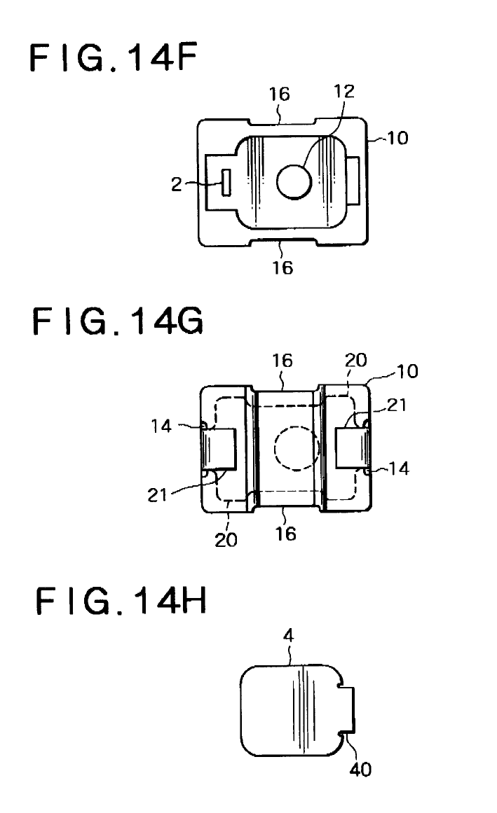

As shown in FIG. 14H, a substantially square plate-shaped thermo-reactive element (a bimetal) 4 having four rounded corners is formed to have an overturned dish-shape or a convex spherical shape in section. The thermo-reactive element 4 is housed in the case 1 such that a projection part 40 provided on a basal end side (a right end in FIGS. 10 and 11) of the thermo-reactive element 4 is put between the inside of the case body 10 and the inside of the cover body 11. The thermo-reactive element 4 is placed such that a substantially central portion thereof is located in the vicinity of or in contact with a convex-shaped seat part 12 provided on the inner bottom surface of the case body 10, and a tip end thereof is located in the vicinity of a lower surface of a portion close to the tip end of the movable electrode 30.

The movable contact 3 mounted to the tip end of the movable electrode 30 is provided to be in contact with the fixed contact 2 by the spring action of the movable electrode 30. The terminal part 31 extending substantially horizontally toward the tip end of the movable electrode 30 so as to lie on top of the movable electrode 30 through a bent loop-shaped portion is united with the basal end of the movable electrode 30. The terminal part 31 is sized and shaped enough to occupy the greater part of the upper surface of the cover body 11, and the upper surface of the terminal part 31 is exposed to the outside of the cover body 11 along the upper surface thereof.

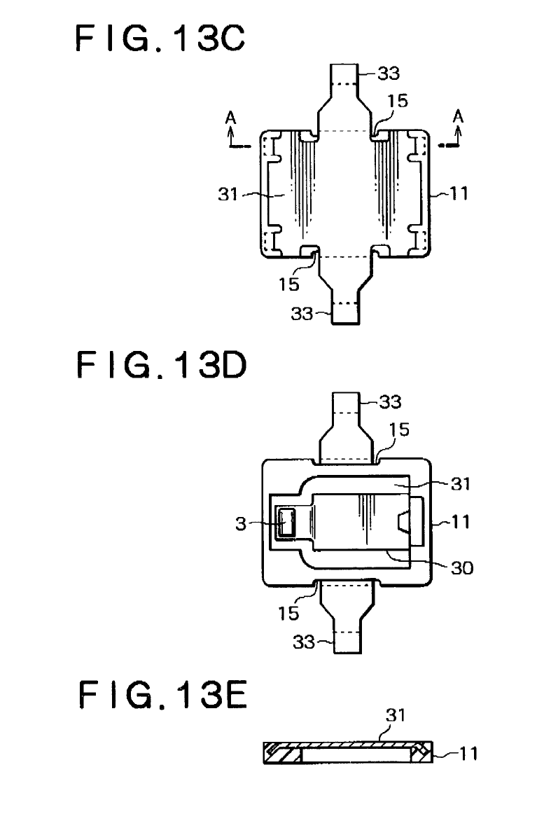

As shown in FIG. 13, the terminal part 31 has, on the opposite sides in a cross direction thereof, a pair of terminal pieces 33, 33 protrusive from the terminal part 31. These terminal pieces 33, 33 are subjected to bending so as to extend in parallel to the bottom surface of the case body 10 and are also substantially level with the terminal parts 21, 21, through notch-shaped guide parts 15, 16 vertically provided on central portions of the opposite side surfaces of the cover body 11 and the case body 10. The thermal pieces 33, 33 are formed as described above, thereby allowing the manufactured thermal protector to have the terminal pieces 33, 33 not to be protrusive from the opposite side portions of the case 1.

Liquid crystal polymer (LCP) or other insulating-resin materials of high heat resistance may be used as the material of the case 1. The case body 10 is united with the fixed contact 2 and the fixed electrode 20 by insert molding such that the fixed contact 2 and the fixed electrode 20 are inlaid in the case body 10. On the other hand, the cover body 11 is united with the movable electrode 30 and the terminal part 31 by insert molding such that the movable electrode 30 and the terminal part 31 are placed as shown in FIGS. 13C and 13D. Then, the cover body 11 is joined with the case body 10 one upon the other in one united body by ultrasonic bonding, for instance, as shown in FIGS. 10 and 11, and thereafter, the terminal pieces 33, 33 provided on the terminal part 31 on the side of the movable electrode 30 are subjected to bending along dotted lines in FIGS. 13C and 13D into a shape shown in FIGS. 10 and 12, thereby providing the thermal protector in final shape.

When the circuit substrates or the like (not shown), for instance, are located on the upper and lower sides to connect the thermal protector of FIG. 10 to the respective wiring electrodes of the lower circuit substrate and the upper circuit substrate, the thermal protector in the ninth embodiment is mounted thereto according to the procedure of selectively mounting a desired portion of the terminal part 31 exposed to the outside of the case 1 along the upper surface thereof to the corresponding wiring electrode of the upper circuit substrate, while mounting each of the terminal parts 21 exposed to the outside of the case 1 along the bottom surface thereof to the corresponding wiring electrode of the lower circuit substrate.

On the other hand, when the thermal protector is connected to the wiring electrodes of the circuit substrates located on the same plane, the terminal part 21 and the terminal pieces 33 respectively exposed to the outside of the case 1 along the bottom surface thereof are respectively mounted to the corresponding wiring electrodes.

When the target circuit substrates or the like for mounting the thermal protector are located not only on the upper and lower sides but also on the same plane, either of one terminal part 31 and the terminal pieces 33 provided on the terminal part 31 may be selected to selectively mount thereto as described above, thereby further increasing a degree of freedom of mounting of the thermal protector.

Other constitution, operation and effects of the thermal protector in the ninth embodiment are substantially similar to those of the thermal protector in the seventh embodiment, and hence, a detailed description thereof will be omitted.

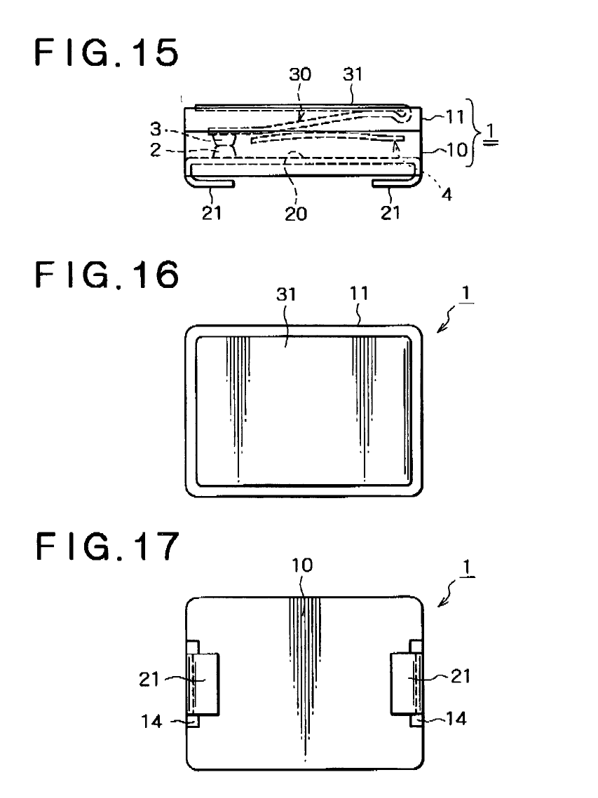

A tenth embodiment of the thermal protector according to the present invention will now be described with reference to FIGS. 15 to 17.

The thermal protector shown in FIGS. 15 to 17 corresponds to a thermal protector according to claims 3, 7, 14 and 18, which will be described later.

A terminal part 31 on the side of a movable electrode 30 is mounted to an upper surface of a cover body 11 of a case 1 so as to be inlaid in the upper surface thereof such as to be slightly protrusive from the upper surface thereof. In addition, the terminal part 31 has the substantially same planar shape as the cover body 11, and a plane area of the terminal part 31 is slightly smaller than that of the cover body 11. The terminal part 31 has no terminal pieces such as those provided on the terminal part of the thermal protector in the ninth embodiment.

The thermal protector in the tenth embodiment is suitably adaptable for mounting to the circuit substrates or the like located on the upper and lower sides.

Other constitution, operation and effects of the thermal protector in the tenth embodiment are substantially similar to those of the thermal protector in the ninth embodiment, and hence, a detailed description thereof will be omitted.

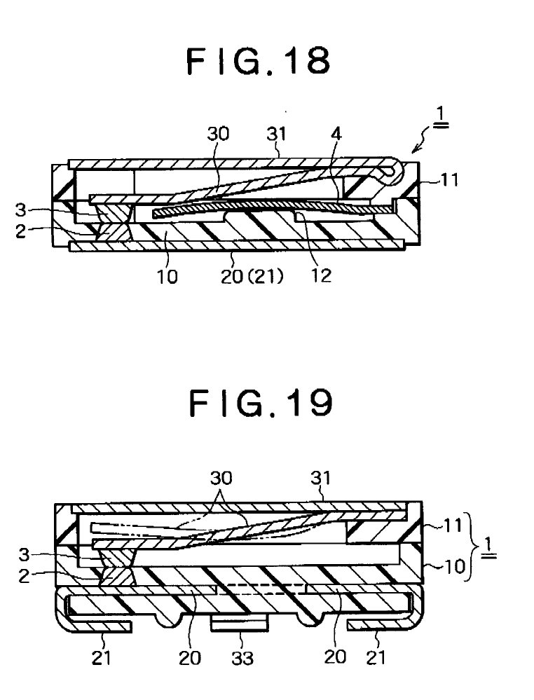

An eleventh embodiment of the thermal protector according to the present invention will now be described with reference to FIG. 18.

The thermal protector shown in FIG. 18 corresponds to a thermal protector according to claims 3, 7, 14 and 17, which will be described later.

A fixed electrode 20 having a fixed contact 2 is mounted to a bottom surface of a case body 10 of a case 1 so as to be inlaid in the bottom surface thereof such as to be slightly protrusive from the bottom surface thereof and also serves as a terminal part 21. The terminal part 21 has the same bottom surface shape as the case body 10, and a bottom area of the terminal part 21 is slightly smaller than that of the case body 10. Thus, the terminal part 21 is provided so as to extend along the bottom surface of the case body 10, and also to occupy the greater part of the bottom surface thereof.

On the other hand, a terminal part 31 of a movable electrode 30 and a thermo-reactive element 4 of the thermal protector in the eleventh embodiment are provided to be substantially similar in structure to those of the thermal protector in the tenth embodiment.

The thermal protector in the eleventh embodiment is suitably adaptable for mounting to the circuit substrates or the like located on the upper and lower sides, and is structured such that both the terminal parts 21, 31 are provided so as to occupy the greater part of the upper and lower surfaces of the case 1, through which the terminal parts 21, 31 are exposed to the outside, so that desired portions of the terminal parts 21, 31 are selectively connected to the wiring electrodes of the circuit substrates or the like, thereby proportionally increasing the degree of freedom of mounting of the thermal protector.

In addition, the thermal protector in the eleventh embodiment is structured such that both the terminal parts 21, 31 are mounted to the upper and lower surfaces of the case 1, through which the terminal parts 21, 31 are exposed to the outside, so as to be inlaid in the upper and lower surfaces thereof, thereby being producible to have a smaller thickness, in other words, a smaller size as a whole.

Other constitution, operation and effects of the thermal protector in the eleventh embodiment are substantially similar to those of the thermal protector in the ninth embodiment, and hence, a detailed description thereof will be omitted.

A twelfth embodiment of the thermal protector according to the present invention will now be described with reference to FIG. 19.

The thermal protector shown in FIG. 19 corresponds to a thermal protector according to claims 3, 7, 18 and 19, which will be described later.

A springy thermo-reactive element is used for a movable electrode 30. Thus, a movable contact 3 is provided to be in contact with a fixed contact by the spring action of the movable electrode 30. On the other hand, when the temperature on the inside of the case rises up to the operating temperature or above of the movable electrode 30 serving as the thermo-reactive element, the movable electrode 30 is snapped by the snap action thereof as shown by an alternate two long and short dash line, thereby allowing the movable contact 3 to disconnect from the fixed contact 2, resulting in a breaking of a circuit.

Other constitution, operation and effects of the thermal protector in the twelfth embodiment are substantially similar to those of the thermal protector in the ninth embodiment, and hence, a detailed description thereof will be omitted.

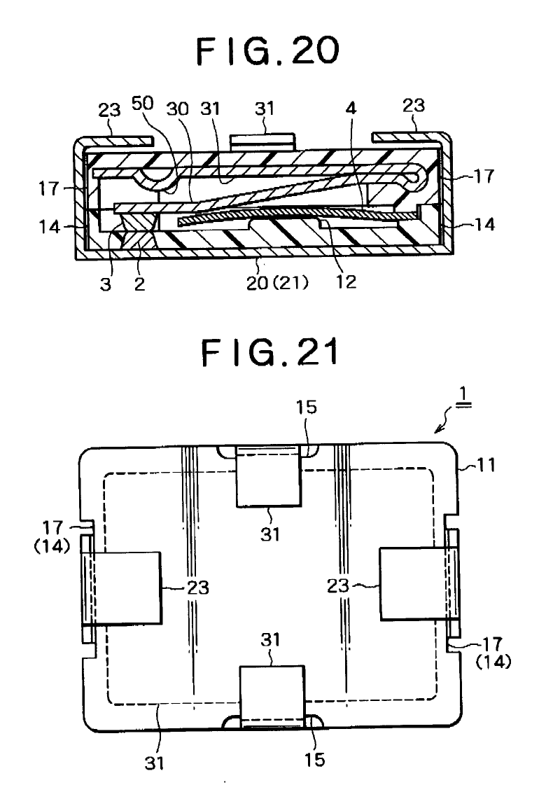

Alternatively, the terminal part 21 of the thermal protector in the twelfth embodiment may be also formed like one, which has been described with reference to FIG. 18, or one, which will be described later with reference to FIG. 20.

A thirteenth embodiment of the thermal protector according to the present invention will now be described with reference to FIGS. 20 to 22.

The thermal protector shown in FIGS. 20 to 22 corresponds to a thermal protector according to claims 3, 7, 13 and 20, which will be described later.

A movable electrode 30 and a terminal part 31 thereof are subjected to bending to have a V-shape in section.

The terminal part 31 of the movable electrode 30 has a portion united with an inner side surface of a top surface wall of a cover body 11b of a case 1 by insert molding so as to lie top of the movable electrode 30. The above portion of the terminal part 31 has, on an inner surface thereof, a projection 50. Thus, when a thermo-reactive element 4 is snapped when a predetermined operating temperature thereof is reached, the movable electrode 30 collides against the projection 50, thereby preventing the movable electrode 30 from being crept in excess of the limitation of elasticity thereof.

The terminal 31 also has a different portion, other than the above portion thereof, extending from two portions thereof toward the opposite sides of the cover body 11. These two portions are subjected to bending such that the tip ends thereof are substantially level with each other and also extend in parallel to an upper surface of the cover body 11, through notch-shaped guide parts 15 vertically provided on the opposite sides of the cover body 11.

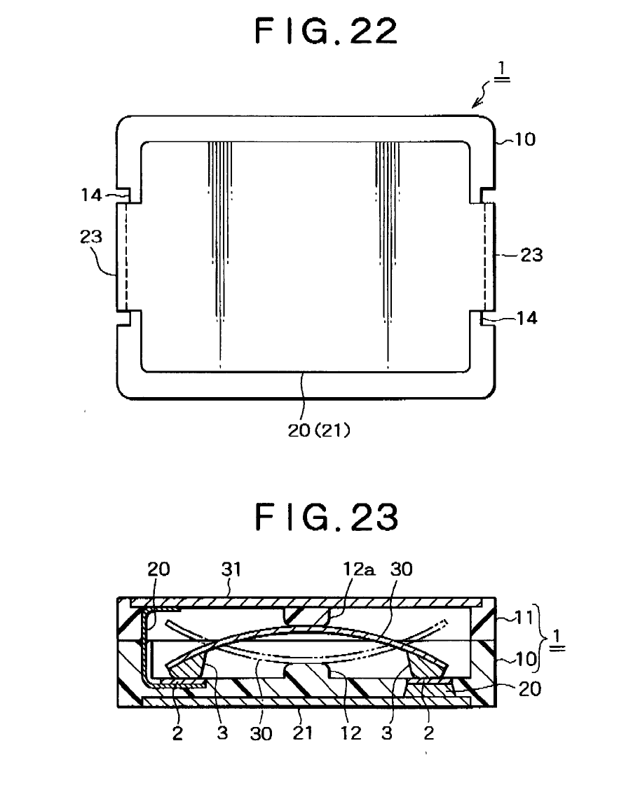

A fixed electrode 20 connected to a fixed contact 2 also serves as a terminal part 21, which forms the substantially same surface as a bottom surface of a case body 10 of the case 1. The terminal part 21 is mounted to the bottom surface of the case body 10 so as to be inlaid in the bottom surface thereof such as to occupy the greater part of the bottom surface thereof as shown in FIG. 22.

The terminal part 21 has, on central portions of the longitudinally opposite ends thereof, terminal pieces 23, 23 protrusive therefrom. The terminal pieces 23, 23 are subjected to bending such that the tip ends thereof extend in parallel to the upper surface of the cover body 11 and are also substantially level with the terminal part 31, through notch-shaped guide parts 15 vertically provided on the central portions of the longitudinally opposite ends of the case body 10 and the cover body 11. The terminal pieces 23, 23 are subjected to bending as described above, after the case body 10 and the cover body 11 respectively provided in one united body by insert molding are joined together by ultrasonic bonding or the like.

When the circuit substrates of the electric appliance (not shown), for instance are located in parallel on the upper and lower sides to connect the thermal protector shown in FIG. 20 to the wiring electrodes of the lower circuit substrate and the upper circuit substrate, the thermal protector in the thirteenth embodiment is mounted thereto according to the procedure of selectively mounting a required portion of the terminal part 21 exposed to the outside of the case 1 along the lower surface thereof to the corresponding wiring electrode of the lower circuit substrate, while mounting the terminal electrode 31 exposed to the outside of the case 1 along the upper surface thereof to the corresponding wiring electrode of the upper circuit substrate.

On the other hand, when the thermal protector is connected to the wiring electrodes of the circuit substrates located on the same plane, the thermal protector is mounted thereto according to the procedure of mounting the terminal pieces 23 and the terminal part 31 respectively exposed to the outside of the case 1 along the upper surface thereof to the corresponding wiring electrodes.

Other constitution, operation and effects of the thermal protector in the thirteenth embodiment are substantially similar to those of the thermal protector in the ninth embodiment, and hence, a detailed description thereof will be omitted.

A fourteenth embodiment of the thermal protector according to the present invention will now be described with reference to FIG. 23.

The thermal protector shown in FIG. 23 corresponds to a thermal protector according to claims 5, 8, which will be described later.

In a case 1 composed of a case body 10 and a cover body 11 provided to seal up the case body 10 are sealed up a pair of fixed contacts 2, 2 and a movable electrode 30 made up of a thermo-reactive element whose opposite ends have movable contacts 3, 3 corresponding to the fixed contacts 2, 2.

Two fixed electrodes 20, 20 respectively connected to the fixed contacts 2, 2 respectively have flat terminal parts 21, 31 exposed to the outside of the case 1. One terminal part 21 is placed along a bottom surface of the case 1, while the other terminal part 31 is placed along an upper surface of the case 1.

The fixed contacts 2, 2 are mounted to the opposite ends of an inner bottom surface of the case body 10 so as to be inlaid in the inner bottom surface thereof. The one terminal part 21 mounted to the bottom surface of the case body 10 by insert molding so as to be inlaid in the bottom surface thereof such as to be substantially level with the bottom surface thereof and also to occupy the greater part of the bottom surface thereof is connected to one fixed contact 2 through one fixed electrode 20. When the fixed contact 2 is united with the fixed electrode 20, the above one terminal part 21 also serves as the above one fixed electrode.

The other terminal part 31 mounted to the upper surface of the cover body 11 by insert molding so as to be inlaid in the upper surface thereof such as to be substantially level with the upper surface thereof and also to occupy the greater part of the upper surface thereof is connected to the other fixed contact 2 through the other thin foil-shaped fixed electrode 20 extending along the inner surface of the cover body 11. The end of the foil-shaped fixed electrode 20 is joined with the terminal part 31 by welding or the like, before the case body 10 and the cover body 11 are joined together.

The movable electrode 30 made up of the thermo-reactive element is formed to have a conical shape or a convex semicircular shape in section. In normal operation, the movable electrode 30 allows, by elasticity thereof, the movable contacts 3, 3 to make contact with the corresponding fixed contacts 2, 2 such that a portion of the movable electrode 30 makes contact with or is located in the vicinity of a convex-shaped seat part 12a (made of a resin) provided on an inner top surface of the cover body 11.

When the temperature on the inside of the case 1 rises up to the operating temperature or above of the movable electrode 30, the movable electrode 30 is snapped into a concave spherical shape as shown by an alternate long and short dash line in FIG. 23 by the snap action thereof, thereby allowing the movable contacts 3, 3 to disconnect from the corresponding fixed contacts 2, 2, resulting in a breaking of a circuit.

The thermal protector in the fourteenth embodiment shown in FIG. 23 is suitably adaptable for mounting to the circuit substrates or the like located in parallel at predetermined intervals. In this case, this thermal protector is mounted thereto according to the procedure of selectively mounting a proper portion of one terminal part 31 to the wiring electrode of one circuit substrate, while selectively mounting a proper portion of the other terminal part 21 to the wiring electrode of the other circuit substrate. As described above, the thermal protector in the fourteenth embodiment may be mounted to the circuit substrates or the like by selectively connecting the proper portions of the terminal parts 21, 31 to the wiring electrodes of the circuit substrates or the like depending on the positions of the corresponding terminal parts in the wiring electrodes of the circuit substrates or the like, thereby further increasing the degree of freedom of mounting of the thermal protector.

In addition, the terminal parts 21, 31 are mounted to the corresponding outer surfaces of the case 1 so as to be inlaid in the outer surfaces thereof, so that the thermal protector in the fourteenth embodiment is producible to have a smaller thickness, in other words, a smaller size.

Further, the thermal protector in the fourteenth embodiment is mounted to the circuit substrates or the like without the need for leads, resulting in a decrease in electric resistance.

Alternatively, the terminal parts 21, 31 of the thermal protector in the fourteenth embodiment shown in FIG. 23 may be also formed like those of the thermal protector in the ninth embodiment shown in FIG. 10, the tenth embodiment shown in FIG. 15 or the thirteenth embodiment shown in FIG. 20.

It is to be understood that the materials of the case 1, the contacts 2, 3, the fixed electrode 20 and the terminal parts 21, 31 of the thermal protector in the fourteenth embodiment are the same as those as described in the thermal protector in the first embodiment shown in FIG. 1. In addition, it is also to be understood that the material of the movable electrode 30 of the thermal protector in the fourteenth embodiment is the same as that of the thermo-reactive element 4 of the thermal protector in the first embodiment shown in FIG. 1.

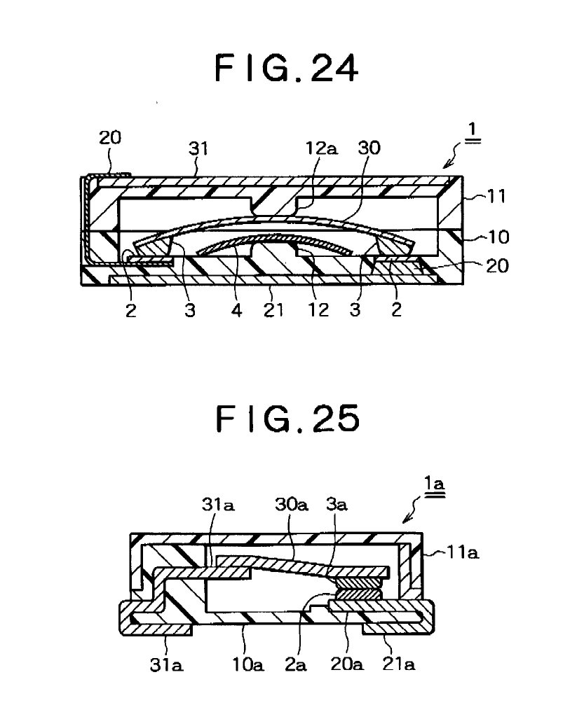

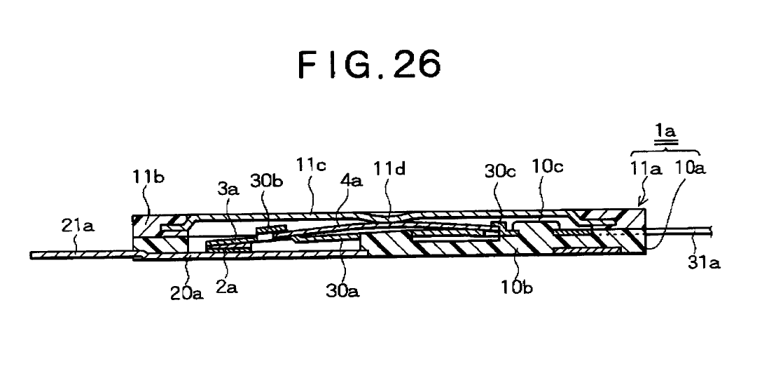

A fifteenth embodiment of the thermal protector according to the present invention will now be described with reference to FIG. 24.

The thermal protector shown in FIG. 24 corresponds to a thermal protector according to claims 4 and 8, which will be described later.

In a case 1 composed of a case body 10 and a cover body 11 provided to seal up the case body 10 are sealed up a pair of fixed contacts 2, 2, a springy movable electrode 30 whose opposite ends have movable contacts 3, 3 corresponding to the fixed contacts 2, 2, and a thermo-reactive element 4 snapped when a predetermined operating temperature or above thereof is reached.

Two fixed electrodes 20, 20 respectively connected to the fixed contacts 2, 2 respectively have flat terminal parts 21, 31 exposed to the outside of the case 1. One terminal part 21 is placed along a bottom surface of the case 1, while the other terminal part 31 is placed along an upper surface of the case 1.

The fixed contacts 2, 2 are mounted to the opposite ends of an inner bottom surface of the case body 10 so as to be inlaid in the inner bottom surface thereof in the similar manner to the thermal protector in the fourteenth embodiment shown in FIG. 23. One terminal part 21 mounted to the bottom surface of the case body 10 by insert molding so as to be inlaid in the bottom surface thereof such as to be substantially level with the bottom surface thereof and also to occupy the greater part of the bottom surface thereof is connected to one fixed contact 2 through one fixed electrode 20. When the fixed contact 2 is united with the above one fixed electrode 20, the above one terminal part also serves as the fixed electrode.

The other terminal part 31 mounted to the upper surface of the cover body 11 by insert molding so as to be inlaid in the upper surface thereof such as to be substantially level with the upper surface thereof and also to occupy the greater part of the upper surface thereof is connected to the other fixed contact 2 through the other foil-shaped fixed electrode 20 extending toward the longitudinal end of the case 1. The foil-shaped fixed electrode 20 is provided to lead upwards along notch-shaped guide parts vertically provided on the end of the case 1, and the upper end of the fixed electrode 20 is joined with the end of the terminal part 31 by welding or the like.

The movable electrode 30 is formed to have a conical shape or a convex semicircular shape in section. In normal operation, the movable electrode 30 allows, by elasticity thereof, the movable contacts 3, 3 to make contact with the corresponding fixed contacts 2, 2 such that a portion of the movable electrode 30 makes contact with a convex-shaped seat part 12a provided on an inner top surface of the cover body 11.

The plate-shaped thermo-reactive element 4 formed in a conical shape or a convex semicircular shape in section is housed in the case 1 so as to be located between the movable electrode 30 and the bottom surface of the case body 10 such that a portion of the thermo-reactive element 4 makes contact with a convex-shaped seat part12 provided on the inner bottom surface of the case body 10. When the temperature on the inside of the case 2 rises up to the operating temperature or above of the thermo-reactive element 4, the thermo-reactive element 4 is snapped into a concave semicircular shape in section such as to make contact with the convex-shaped seat part 12 on the side of the cover body 10 by the snap action thereof, thereby allowing the movable electrode 30 to creep to disconnect the movable contacts 3, 3 from the corresponding fixed contacts 2, 2, resulting in a breaking of a circuit.

Other operation and effects of the thermal protector in the fifteenth embodiment of FIG. 24 are substantially similar to those of the thermal protector in the fourteenth embodiment of FIG. 23, and hence, a detailed description thereof will be omitted.

Alternatively, the terminal parts 21, 31 of the thermal protector in the fifteenth embodiment shown in FIG. 24 may be formed like those of the thermal protector in the ninth embodiment shown in FIG. 10, the tenth embodiment shown in FIG. 15 or the thirteenth embodiment shown in FIG. 20.

It is to be understood that the materials of the case 1, the contacts 2, 3, the fixed electrodes 20, the movable electrode 30, the thermo-reactive element 4 and the terminal parts 21, 31 of the thermal protector in the fifteenth embodiment are the same as those of the thermal protector in the first embodiment shown in FIG. 1.

The thermal protector according to the present invention is considered to be a thermal protector, which has a smaller sizes is less need for an assemble step and ensures a higher size accuracy. In addition, it is also considered to be a thermal protector, which is highly yielded and also easily ensures that the structural strength is provided for the whole structure. In consequence, the thermal protector according to the present invention is quite adaptable for the industrial use.

What is claimed is:

1. A thermal protector, comprising:
an insulating resin-made flat case having a case body and a cover body joined with said case body;
a fixed electrode having a fixed contact located on an inner bottom portion of said case body and a terminal part exposed to the outside of said case body, said fixed electrode being fixed to said case body;
a movable electrode having, on a tip end thereof, a movable contact, while having, on a basal end thereof, a terminal part fixed to said cover body and having a portion exposed to the outside of said cover body, said movable electrode being placed such as to allow, by a spring action thereof, said movable contact to make contact with said fixed contact, the basal end of said movable electrode being fixed to said cover body; and
a thermo-reactive element housed in said case so as to allow said movable electrode to operate to disconnect said movable contact from said fixed contact when a predetermined operating temperature of said thermo-reactive element is reached.

2. A thermal protector, comprising;
an insulating resin-made flat case having a case body and a cover body joined with said case body;
a fixed electrode having a fixed contact located on an inner bottom portion of said case body and a terminal part exposed to the outside of said case body, said fixed electrode being fixed to said case body; and
a movable electrode made up of a thermo-reactive element having, on a tip end thereof, a movable contact, while having, on a basal end thereof, a terminal part fixed to said cover body and having a portion exposed to the outside of said cover body, said thermo-reactive element being placed such as to allow, by a spring action thereof, said movable contact to make contact with said fixed contact, while allowing said movable contact to disconnect from said fixed contact when a predetermined operating temperature of said thermo-reactive element is reached, the basal end of said thermo-reactive element being fixed to said cover body.

3. The thermal protector according to claim 1 or 2, wherein the terminal part of said fixed electrode is formed in a plate shape and is placed such that at least a portion thereof extends along the bottom surface of said case body, and the terminal part of said movable electrode is formed in a plate shape and is placed such that at least a portion thereof extends along the upper surface of said cover body.

4. A thermal protector, comprising:
an insulating resin-made flat case having a case body and a cover body joined with said case body;
a fixed electrode having a fixed contact located on an inner bottom portion of said case body and a plate-shaped terminal part having at least a portion exposed to the outside of said case body along the bottom surface thereof, said fixed electrode being fixed to said case body;
a different fixed electrode having a different fixed contact located on an inner bottom portion of said case body so as to keep away from said fixed electrode, and a different plate-shaped terminal part fixed to said cover body such that at least a portion of said different plate-shaped terminal part is exposed to the outside of said cover body along the upper surface thereof, said different fixed electrode being fixed to said case body;
a movable electrode having, on the opposite ends thereof, movable contacts corresponding to said fixed contacts, said movable electrode being housed in said case such as to allow, by a spring action thereof, each of said movable contacts to make contact with a corresponding one of said fixed contacts; and
a thermo-reactive element housed in said case so as to allow said movable electrode to operate to disconnect each of said movable contacts from the corresponding one of said fixed contacts when a predetermined operating temperature of said thermo-reactive element is reached.

5. A thermal protector, comprising:
an insulating resin-made flat case having a case body and a cover body joined with said case body;
a fixed electrode having a fixed contact located on an inner bottom portion of said case body and a plate-shaped terminal part having at least a portion exposed to the outside of said case body along the bottom surface thereof, said fixed electrode being fixed to said case body;
a different fixed electrode having a different fixed electrode located on an inner bottom portion of said case body so as to keep away from said fixed electrode, and a different plate-shaped terminal part fixed to said cover body such that at least a portion of said different plate-shaped terminal part is exposed to the outside of said cover body along the upper surface thereof, said different fixed electrode being fixed to said case body; and
a movable electrode made up of a thermo-reactive element having, on the opposite ends thereof, movable contacts corresponding to said fixed contacts, said thermo-reactive element being housed in said case such as to allow, by a spring action thereof, each of said movable contacts to make contact with a corresponding one of said fixed contacts, while allowing each of said movable contacts to disconnect from the corresponding one of said fixed contacts when a predetermined operating temperature of said thermo-reactive element is reached.

6. The thermal protector according to claim 1 or 2, wherein said fixed electrode is united with said case body by insert molding, and the terminal part of said movable electrode is united with said cover body by insert molding, each of said terminal parts being provided to extend from said case sideward.

7. The thermal protector according to claim 3, wherein said fixed electrode is united with said case body by insert molding, and the terminal part of said movable electrode is united with said cover body by insert molding.

8. The thermal protector according to claim 4 or 5, wherein each of said fixed electrodes is united with said case body by insert molding, and said different terminal part is united with said cover body by insert molding, said different terminal part being also connected to said different fixed electrode.

9. The thermal protector according to claim 6 or 7, wherein said fixed electrode has a strip-shaped projection extending in a fixed direction thereof.

10. The thermal protector according to claim 6, wherein it further comprises a heat conductive plate of high thermal conductivity, and said heat conductive plate whose one end is connected to the basal end of said movable electrode is united with a top surface wall of said cover body by insert molding.

11. The thermal protector according to claim 10, wherein said heat conductive plate is made of a conductive material, and one surface of said heat conductive plate is wholly or partly exposed to the outside of said cover body along the upper surface thereof.

12. The thermal protector according to claim 10, wherein said heat conductive plate has a projection such that said movable electrode collides against said projection when said movable contact is disconnected from said fixed contact so as to be apart therefrom by a certain distance.

13. The thermal protector according to claim 7, wherein a portion of the terminal part of said movable electrode is united with the inner surface of the top surface wall of said cover body, and a different portion of the terminal part of said movable electrode is subjected to bending so as to extend along the upper surface of said cover body.

14. The thermal protector according to claim 7, wherein one surface of the terminal part of said movable electrode is wholly or partly exposed to the outside of said cover body along the upper surface thereof.

15. The thermal protector according to claim 14, wherein the terminal part of said movable electrode is provided separately from said movable electrode and is also connected to the basal end of said movable electrode.

16. The thermal protector according to claim 13 or 14, wherein the terminal part of said movable electrode has a projection such that said movable electrode collides against said projection when said movable contact is disconnected from said fixed contact so as to be apart therefrom by a certain distance.

17. The thermal protector according to claim 14, wherein one surface of the terminal part of said fixed electrode is wholly or partly exposed to the outside of said case body along the bottom surface thereof.

18. The thermal protector according to claim 14, wherein the terminal part of said fixed electrode is subjected to bending so as to extend along the bottom surface of said case body.

19. The thermal protector according to claim 18, wherein the terminal part of said movable electrode has one or more terminal pieces extending toward the bottom surface of said case body, said terminal pieces being subjected to bending such that the tip ends thereof extend along the bottom surface of said case body such as to be substantially level with the end of the terminal part of said fixed electrode.

20. The thermal protector according to claim 13, wherein one surface of the terminal part of said fixed electrode is wholly or partly exposed to the outside of said case body along the bottom surface thereof, and the terminal part of said fixed electrode has one or more terminal pieces extending toward the upper surface of said cover body, said terminal pieces being subjected to bending such that the tip ends thereof extend along the upper surface of said cover body such as to be substantially level with said different portion of the terminal part of said movable electrode.
